(19) United States
(12) Patent Application Publication
(10) Pub. No.: US 2025/0388709 A1
(43) Pub. Date: Dec. 25, 2025

(54) Polyolefin Elastomeric Ionomers And Methods Related Thereto

(71) Applicant: ExxonMobil Chemical Patents Inc., Baytown, TX (US)

(72) Inventors: Krishnan Anantha Narayana Iyer, Houston, TX (US); Antonios K. Doufas, Houston, TX (US); Qingyu Zhu, Shanghai (CN); Dawei Wang, Shanghai (CN); Tian Li, Shanghai (CN); Gang Huang, Singapore (SG)

(21) Appl. No.: 18/877,696

(22) PCT Filed: Jun. 16, 2023
(86) PCT No.: PCT/US2023/068557

§ 371 Date: Dec. 20, 2024

Related U.S. Application Data
(60) Provisional application No. 63/391,092, filed on Jul. 21, 2022.

(51) Int. Cl. C08F 10/06; C08K 5/098; C08K 5/43

(52) U.S. Cl. CPC C08F 10/06; C08K 5/098; C08K 5/43

(57) ABSTRACT

Polyolefin elastomeric ionomers and methods related thereto and, more particularly, to propylene-based elastomeric ionomers and methods of production and use related thereto. The polyolefin elastomeric ionomers include at least a polyolefin component and metal-based neutralization agent component. The polyolefin elastomeric ionomers can exhibit improved elasticity at body temperature or at higher temperatures.

### CROSS-REFERENCE TO RELATED APPLICATIONS

This application claims the benefit of U.S. Provisional Application No. 63/391,092, filed on Jul. 21, 2022, the entire contents of which are incorporated herein by reference.

### FIELD OF INVENTION

This application relates to polyolefin elastomeric ionomers and methods related thereto and, more particularly, to propylene-based elastomeric ionomers and methods of production and use related thereto.

### BACKGROUND

Elastomers (e.g., rubbers) and elastomeric layered constructs are commonly used for a wide variety of applications, including, consumer products, such as disposable hygiene products. These disposable hygiene products may include diapers, training pants, and adult incontinence products and require ample elastic properties at room temperature and body temperature, such as in the waist, ears, side panels, and cuff regions, for effective use.

Elastomeric constructs, such as elastomeric laminate films or elastomeric nonwoven webs, based on styrenic block copolymers (SBCs) exhibit excellent elastic and thermal physical properties; however, constructs based entirely on SBCs are costly, and often prohibitively so for use in consumer products. Less costly SBCs include, for example, those that are unhydrogenated SBCs (e.g., styrene-isoprene-styrene, styrene-butadienestyrene, and the like) and hydrogenated midblock SBCs (e.g., styrene-ethylene/butylene-styrene, styreneethylene/propylene-styrene, and the like). However, unhydrogenated SBCs exhibit a limited process window due to poor thermal degradation, processability, and reduced mechanical performance; hydrogenated midblock SBCs can comparatively exhibit greater thermal stability but are costly to manufacture.

More environmentally and economically friendly elastomers, such as polyolefin-based elastomers, compared to SBCs, however, currently suffer from limited elasticity and heat resistance, and those current elastomers that meet the elasticity requirements for such consumer products, can be difficult to handle due to tackiness and other processability impediments, and often require crosslinking to balance properties, particularly at body temperature conditions or high temperatures.

Accordingly, there is a need for polyolefin-based elastomers that demonstrate ample elasticity and thermal stability, as an alternative to SBCs.

### SUMMARY OF INVENTION

This application relates to polyolefin elastomeric ionomers and methods related thereto and, more particularly, to propylene-based elastomeric ionomers and methods of production and use related thereto.

In one or more aspects, the present disclosure provides a functionalized polyolefin elastomeric ionomer composition. The composition includes a reaction product of a polyolefin component, at least 0.1 parts by weight of a sulfonyl azide derivative component, and a metal-based neutralizing agent component containing an elemental metal or a metal compound comprising at least one of aluminum, calcium, magnesium, sodium, and zinc. The sulfonyl azide derivative component functionalizes the polyolefin component. The sulfonyl azide derivative component comprises at least one of an organic anhydride compound or an organic acid compound and is present in an amount of per 100 parts by weight of polyolefin component. A degree of neutralization of the one or both organic anhydride component or organic acid component of the sulfonyl azide derivative component is at least 20%.

In one or more aspects, the present disclosure provides a method of melt mixing a polyolefin component, at least 0.1 parts by weight of a sulfonyl azide derivative component, and a metal-based neutralizing agent component containing an elemental metal or a metal compound comprising at least one of aluminum, calcium, magnesium, sodium, and zinc. The sulfonyl azide derivative component functionalizes the polyolefin component. The sulfonyl azide derivative component comprises at least one of an organic anhydride compound or an organic acid compound and is present in an amount of per 100 parts by weight of polyolefin component. A degree of neutralization of the one or both organic anhydride component or organic acid component of the sulfonyl azide derivative component is at least 20%.

In one or more aspects, the present disclosure provides a carboxylic propylene elastomeric ionomer composition. The composition includes the reaction product of a polyolefin component grafted with an acid hydride and a hydroxide metal-based neutralizing agent component containing an elemental metal or a metal compound comprising at least one of potassium, sodium, or calcium.

These and other features and attributes of the disclosed polyolefin elastomeric ionomers of the present disclosure and their advantageous applications and/or uses will be apparent from the detailed description which follows.

### BRIEF DESCRIPTION OF THE DRAWINGS

To assist those of ordinary skill in the relevant art in making and using the subject matter hereof, reference is made to the appended drawings. The following figures are included to illustrate certain aspects of the disclosure, and should not be viewed as exclusive configurations. The subject matter disclosed is capable of considerable modifications, alterations, combinations, and equivalents in form and function, as will occur to those skilled in the art and having the benefit of this disclosure.

FIG. 1 is a reaction scheme for the preparation of representative azidosulfonylbenzoic acid carboxylic propylene elastomeric ionomers, according to one or more aspects of the present disclosure.

FIGS. 2A and 2B show small amplitude oscillatory shear measurements of a representative azidosulfonylbenzoic acid carboxylic propylene elastomeric ionomers compared to a traditional polyolefin elastomer, according to one or more aspects of the present disclosure.

FIG. 3 shows properties of a representative azidosulfonylbenzoic acid carboxylic propylene elastomeric ionomer compared to traditional polyolefin elastomers, according to one or more aspects of the present disclosure.

FIG. 4 is a differential molecular weight (dWf/dLogM) curve for commercially available maleic acid grafted propylene-based elastomers.

FIGS. 5A through 5C show small amplitude oscillatory shear measurements of representative carboxylic propylene elastomeric ionomers grafted with maleic acid and ionomerized via a reaction with potassium hydroxide compared to a traditional maleic acid grafted polyolefin elastomer, according to one or more aspects of the present disclosure.

FIG. 6 is a plot that shows tensile strength and elongation properties of representative carboxylic propylene elastomeric ionomers grafted with maleic acid and ionomerized via a reaction with potassium hydroxide compared to a traditional maleic acid grafted polyolefin elastomer, according to one or more aspects of the present disclosure.

FIGS. 7A through 7D show Dynamic Mechanical Thermal Analysis measurements of representative carboxylic propylene elastomeric ionomers grafted with maleic acid and ionomerized via a reaction with potassium hydroxide compared to a traditional maleic acid grafted polyolefin elastomer, according to one or more aspects of the present disclosure.

FIG. 8 is a Fourier transform infrared spectroscopy measurement of representative carboxylic propylene elastomeric ionomers grafted with maleic acid and ionomerized via a reaction with potassium hydroxide compared to a traditional maleic acid grafted polyolefin elastomer, according to one or more aspects of the present disclosure.

FIG. 9 is a chart showing compression set data of representative carboxylic propylene elastomeric ionomers grafted with maleic acid and ionomerized via a reaction with potassium hydroxide compared to a traditional maleic acid grafted polyolefin elastomer, according to one or more aspects of the present disclosure.

FIGS. 10A and 10B show tensile strength (stress) data of representative carboxylic propylene elastomeric ionomers grafted with maleic acid and ionomerized via a reaction with potassium hydroxide compared to a traditional maleic acid grafted polyolefin elastomer, according to one or more aspects of the present disclosure.

FIGS. 11A and 11B show elastic recovery data of representative carboxylic propylene elastomeric ionomers grafted with maleic acid and ionomerized via a reaction with potassium hydroxide compared to a traditional maleic acid grafted polyolefin elastomer, according to one or more aspects of the present disclosure.

### DETAILED DESCRIPTION

This application relates to polyolefin elastomeric ionomers and methods related thereto and, more particularly, to propylene-based elastomeric ionomers and methods of production and use related thereto.

The polyolefin-based elastomeric ionomers obtained by one or more reactions of the present disclosure exhibit comparatively improved elastic properties at room temperature, body temperature conditions, and high temperature conditions, as well as improved mechanical and structural properties. These polyolefin-based elastomeric ionomers are suitable for replacement or as an alternative to SBCs for consumer disposable hygiene products, for example, which suffer from poor processability and manufacturability (e.g., exhibit tackiness that can stick to rolls or other machinery, and the like), require relatively high CO₂ input, and are costly. The polyolefin-based elastomeric ionomers are also a suitable replacement for traditional propylene-based elastomers, which often lack suitable elasticity and high melt strength, resulting in processability issues such as foaming, high speed sheet extrusion, thermoforming, and the like. While high melt strength may be combated with the addition of long-chain branches to linear polymer structures, the polymer network often becomes rigid and impacts elasticity, or is not suitable for certain converting techniques.

Typical ionomerization employs complex sulfonation procedures or peroxide maleic anhydride grafting, none of which address body temperature elasticity, processability, manufacturability, or tackiness. The present disclosure provides ionomerization using a sulfonyl azide derivate or potassium hydroxide to address these issues.

### Definitions and Test Methods

As used herein, “wt %” means weight percent, “vol %” means volume percent, “parts” means parts by weight, and all molecular weights, e.g., Mw and Mn, are in units of grams per mole (g/mol), unless otherwise noted.

The term “polymer,” and grammatical variants thereof, refers to any carbon-containing compound having repeat units from one or more different monomers and encompasses homopolymers, copolymers, terpolymers, and the like. A “copolymer” is a polymer having two or more monomer units that are different from each other.

As used herein, when a polymer is referred to as comprising a monomer, the monomer is present in the polymer in the polymerized form of the monomer or in the derivative form of the monomer. The term “derived units” as used herein, refers to the polymerized form of the monomer from which the polymer was derived. For example, when a copolymer is said to have an “ethylene” content of 35 wt % to 55 wt %, it is understood that the monomer unit in the copolymer is derived from ethylene in the polymerization reaction and said derived units are present at 35 wt % to 55 wt %, based upon the weight of the copolymer.

As used herein, “elastomer” or “elastomeric composition,” and grammatical variants thereof, refers to any polymer or composition of polymers (such as blends of polymers) consistent with the ASTM D1566-21 (2021) definition. Elastomer includes mixed blends of polymers such as melt mixing and/or reactor blends of polymers. The terms may be used interchangeably with the term “rubber(s).”

As used herein, the term “ionomer,” and grammatical variants thereof, refers to a polymer comprising ionic groups that is stabilized by cross linkages. According to the various aspects of the present disclosure, in order to obtain ionomers having desired characteristics of a fully-crosslinked polymer, such an ionomer should carry on average more than two ionic groups per molecule (molar functionally greater than two). The resultant fully-crosslinked ionomers can be obtained by neutralizing polymers carrying on average just over two functional groups (e.g., carboxyl groups, sulfonic acid groups, and the like, and any combination thereof) to a degree of neutralization of at least 20%, and preferably up to 200%. Alternatively, ionomers having similar performance may be achieved with a functionalized polymer having a molar functionality considerably higher than two and which has been neutralized to such a degree (“degree of neutralization”) as to provide the polymer with on average just over two ionic groups per molecule.

As used herein, the term “degree of neutralization,” and grammatical variants thereof, refers to the number of metal equivalents of a metal-based neutralizing agent used per equivalent of carboxyl groups multiplied by 100%. Thus, when the degree of neutralization exceeds 100%, it indicates the presence of an excess of neutralizing agent, which excess of neutralizing agent will also be present in the thermoplastic elastomer compositions based on such a carboxylated elastomer and thus have a degree of neutralization greater than 100%.

Shore A hardness was measured using a durometer according to ASTM D2240-15 (2021).

Tensile strength, modulus at 100% extension (“M100”), and ultimate elongation were measured on injection molded plaques according to ASTM D412-16 (2021) by using an INSTRON™ testing machine (Massachusetts, USA).

The Tension Set (Method 1) was measured at 70° C. and for 22 h by applying a 25% strain. The samples were taken out under tension and allowed to cool. The measurements were performed 30 min after releasing from tension with a crosshead speed of 100 millimeters per minute (mm/min).

The Tension Set (Method 2) was measured at 70° C. and for 22 h by applying a 100% strain. The samples were taken out under tension and allowed to cool. The measurements were performed 30 min after releasing from tension with a crosshead speed of 100 millimeters per minute (mm/min). The Tension Set (Method 3) was measured at RT and for 10 min by applying a 100% strain.

The samples were taken out under tension and allowed to cool. The measurements were performed 10 min after releasing from tension with a crosshead speed of 100 millimeters per minute (mm/min).

The Tension Set (Method 4?) was measured at 37° C. and for 10 min by applying a 100% strain. The samples were taken out under tension and allowed to cool. The measurements were performed 10 min after releasing from tension with a crosshead speed of 100 millimeters per minute (mm/min).

Elastic recovery was measured according to ASTM D6084-21 (2021) using an RSA rheometer (TA INSTRUMENTS, Delaware, USA) with a tension fixture and a deformation speed of 1 millimeter per second (mm/s).

Dynamic Mechanical Thermal Analysis (DMTA) was measured according to ASTM E1867-18 (2018) using an RSA rheometer (TA INSTRUMENTS, Delaware, USA) at a frequency of 1 Hertz (Hz) and strain of 0.1%.

Specific heat was determined by Differential Scanning calorimetry (DSC) according to ASTM E1269-11 (2018) with a heating and cooling rate of 10° C. per minute (° C./min).

Fourier Transform Infrared Spectroscopy (FTIR) was performed using a NICOLET™ IS50 FT-IR spectrometer (THERMO FISHER SCIENTIFIC, Massachusetts, USA) with a transmission mode of: 4 cm⁻¹ resolution, scan speed of 0.2 centimeters per second (cm/s), and scan number 32.

The compression set was measured at 70° C. and for 22 hours by applying a 25% deflection. The samples are taken out under compression and allowed to cool under compression. The measurements are performed after releasing from compression.

Molecular weight distribution (MWD) was measured using a Gel Permeation Chromatograph equipped with an IR5 infrared detector GPC-4D (POLYMER CHAR, Valencia, Spain), co-monomer content, LCB.

The rheological properties were measured by small amplitude oscillatory shear (SAOS) measurements. The SAOS measurements were completed on an ARES-G2 rheometer (TA INSTRUMENTS, Delaware, USA) with a temperature ramp in a nitrogen atmosphere. The dynamic properties of the ionomer were characterized in the frequency range from 0.1 rad/s to 256 rad/s (logarithmic scaling).

### Sulfonyl Azide Derivative (SAD) Carboxylic Polyolefin Elastomeric Ionomers

In one or more aspects of the present disclosure, provided are carboxylic polyolefin elastomeric ionomers ionomerized via a reaction with a sulfonyl azide derivate (SAD). The polyolefin elastomeric ionomers are at least partially neutralized acid functionalized, as described herein. More particularly, the polyolefin-based elastomeric ionomers of the present disclosure may be formed by the reaction of a polyolefin component, a SAD component, and a metal-based neutralizing agent component. The SAD component comprises organic anhydride or organic acid and may be present in an amount of greater that at least 0.1 parts per weight of the polyolefin component, including up to 10 parts by weight of the polyolefin component, encompassing any value and subset therebetween. The degree of neutralization by use of the metal-based neutralizing agent component may be at least 20%, including up to 200%, encompassing any value and subset therebetween.

Examples of suitable SADs having organic acids may include, but are not limited to, 3-azidosulfonylbenzoic acid, 4-azidosulfonylbenzoic acid, 4-carboxybenzenesulonazide (CBSA), 4-azidosulfonyl-phthalic acid and 4-azidosulfonyl-phenozy-acetic acid, as well as such acids having further substituents attached to the aromatic nucleus, such as, but not limited to, 2-chloro-5-azidosulfonylbenzoic acid, 4-neopentyl-5-azidosulfonylbenzoic acid, 4-ethyl-5-azidosulfonylbenzoic acid, and 2-hydrozy-5-azidosulfonylbenzoic acid. The preferred SAD acid is 4-azidosulfonylbenzoic acid and/or 4-carboxybenzenesulonazide (CBSA). Any of the SAD acids may be used in combination, without departing from the scope of the present disclosure.

Examples of suitable SADs having organic anhydrides may include, but are not limited to, 5-(azidosulfonyl) endo-cis-bicyclo[2.2.1]heptane-2,3-dicarboxylic anhydride, 3-(2,5-dioxotetrahydrofuran-3-yl)-2-methylpropane-1-sulfonyl azide, and the like, and any combination thereof. Another suitable SAD having organic anhydrides, used alone or in combination, is represented by chemical Structure 1 below:

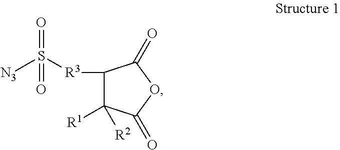

wherein R¹, R², and R³ are each H— or alkyl groups.

Examples of suitable polyolefins include, but are not limited to, propylene-ethylene copolymers, polyethylene, polypropylene, and the like, and any combination thereof.

Any of the SAD acids or SAD anhydrides may be used in combination, without departing from the scope of the present disclosure.

Generally any neutralizing agent may be employed, although metal-based neutralizing agents are preferred. Examples of such metal-based neutralizing agents include oxide-, hydroxide-, salt-, and alcoholate-type neutralizing agents, including, for example, magnesium hydroxide and zinc oxide. When the neutralizing agent is a salt-type neutralizing agent, the salt is preferably based on an acid having a higher acid strength (pKa) than that of the carboxyl groups present in the carboxylated elastomer. Metal oxide-type neutralizing agents are the most preferred, with zinc oxide (ZnO) being the preferred metal oxide-type neutralizing agent.

Generally the degree of neutralization of the carboxyl groups will be at least about 20% and up to 200%, encompassing any value and subset therebetween. That is, the highest degree of coherence for a given carboxylated polymer, as demonstrated by low flow at elevated temperatures and a high tensile strength, may be obtained with fully-crosslinked polymers, thus having a degree of neutralization of 100%. However, it has surprisingly been found that a degree of neutralization exceeding 100% may have a beneficial influence on the tensile properties of the compositions of the elastomeric ionomers described herein. Thus it is preferred to employ carboxylated elastomeric polymers having a degree of neutralization of at least 200%.

In one or more aspects of the present disclosure, it is desirable that the compositions described herein demonstrate some degree of thermoplasticity. Generally, the neutralized SAD carboxylic polyolefin elastomeric ionomers of the present disclosure, particularly those approaching a 100% degree of neutralization, will demonstrate very little or no flow at elevated temperatures, and will require the admixture of a plasticizing compound in order to achieve a sufficient degree of thermoplasticity. Zinc carboxylates have been found to be suitable plasticizers. Although any zinc carboxylate can be used, the carboxylic acid whereon the zinc carboxylate is based, is preferably a linear or branched monocarboxylic acid having at least 12 carbon atoms per molecule. Most preferably the linear monocarboxylic acid is a fatty acid, with stearic acid being the preferred fatty acid. The preferred zinc carboxylate is zinc stearate. The amount of plasticizer is preferably at least 6 parts by weight (pbw) of plasticizer for each 100 pbw of polymer. Most preferably, the weight ratio is in the range of about 10:100 to about 50:100, encompassing any value and subset therebetween.

The zinc carboxylate employed in the present invention may also be prepared in situ, by mixing the corresponding carboxylic acid having at least 12 carbon atoms in its molecule and an amount of neutralizing agent which is preferably at least sufficient to neutralize the carboxyl groups of the carboxylated elastomer as well as those of the carboxylic acid.

Examples of suitable metal-based neutralizing agents include, but are not limited to, elemental metals or metal compounds comprising aluminum, calcium, potassium, magnesium, sodium, zinc, and the like, and any combination thereof. For example, the metal compounds may include hydroxides or oxides comprising aluminum, calcium, potassium, magnesium, sodium, zinc, and the like, and any combination thereof. In preferred embodiments, when the metal-based neutralizing agent is a hydroxide or oxide, the metal portion is potassium, sodium, zinc, calcium, or aluminum. As an additional example, the metal-based neutralizing agent may include a carboxylated copolymer of a calcium or zinc carboxylate based on an acid compound selected from the group consisting of linear and branched monocarboxylic acids having at least 12 carbon atoms per molecule.

In some instances, the SAD carboxylic polyolefin elastomeric ionomers are mechanically melt mixed (e.g., using a reactor or extruder) at a temperature in the range of about 100° C. to about 200° C. in the absence of a free-radical initiator. The SAD carboxylic polyolefin elastomeric ionomers thus produced showed exceptional elastic properties at body temperature as well as at room temperature. Additionally, the SAD carboxylic polyolefin elastomeric ionomers show good high temperature processability as measured by small amplitude oscillatory shear.

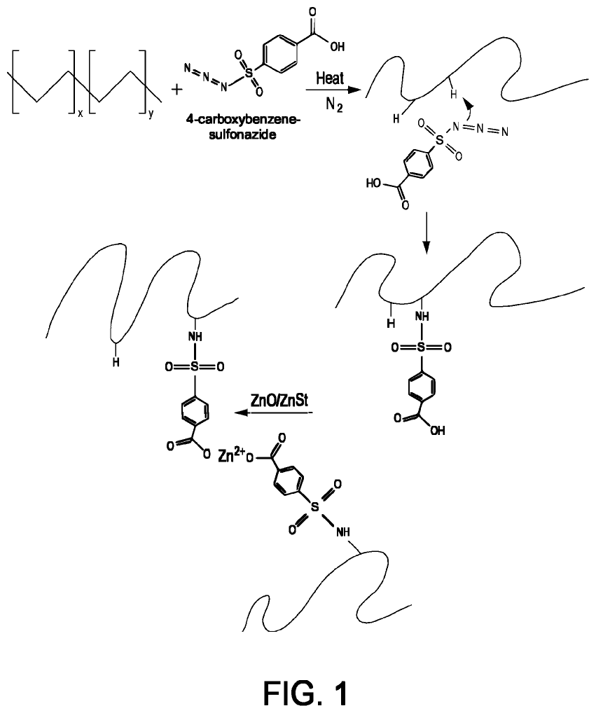

In certain specific aspects, one or more representative SAD carboxylic polyolefin elastomeric ionomers may be azidosulfonyl benzoic acid (ABA) elastomeric ionomers prepared via a reaction with 4-caboxybenzenesulfonamide (CBSA) and subsequently neutralizing the carboxylic acid with Zn salts, such as zinc oxide (ZnO) and/or zinc stearate (ZnSt). FIG. 1 shows a reaction scheme for preparing representative ABA propylene elastomeric ionomers.

The SAD carboxylic polyolefin elastomeric ionomers prepared as described herein may have a Shore A hardness in the range of about 50 to about 80, encompassing any value and subset therebetween, such as about 50 to about 60, or about 60 to about 70, or about 70 to about 80.

The SAD carboxylic polyolefin elastomeric ionomers may have a 100% modulus in the range of about 1 MegaPascal (MPa) to about 2 MPa, encompassing any value and subset therebetween, such as about 1 MPa to about 1.5 MPa, or about 1.5 MPa to about 2 MPa.

The SAD carboxylic polyolefin elastomeric ionomers may have a tensile strength of about 5 MPa to about 20 MPa, encompassing any value and subset therebetween, such as about 5 MPa to about 15 MPa, or about 10 MPa to about 15 MPa, or about 10 MPa to about 12 MPa, or about 12 MPa to about 15 MPa.

The SAD carboxylic polyolefin elastomeric ionomers may have an ultimate elongation of about 400% to about 950%, encompassing any value and subset therebetween, such as about 400% to about 500%, or about 500% to about 600%, or about 600% to about 700%, or about 700% to about 750%, or about 750% to about 800%, or about 800% to about 850%, or about 850% to about 900%, or about 900% to about 950%.

The SAD carboxylic polyolefin elastomeric ionomers may have a 25% elongation at break of about 20% to about 30% at 22 hours and 70° C. upon release after 30 min, encompassing any value and subset therebetween, such as about 20% to about 25%, or about 25% to about 30%.

The SAD carboxylic polyolefin elastomeric ionomers may have 50% elongation at break of about 40% to about 60% at 22 hours and 70° C. upon release after 30 min, encompassing any value and subset therebetween, such as about 40% to about 50%, or about 50% to about 60%.

The SAD carboxylic polyolefin elastomeric ionomers may have a 100% elongation at break of about 1% to about 8% at 10 minutes and RT upon release after 10 minutes, encompassing any value and subset therebetween, such as about 1% to about 5%, or about 5% to about 10%, or about 2% to about 4%, or about 6% to about 8%.

The SAD carboxylic polyolefin elastomeric ionomers may have a 100% elongation at break of about 3% to about 25% at 10 minutes and 37° C. upon release after 10 minutes, encompassing any value and subset therebetween, such as about 3% to about 20%, or about 5% to about 10%, or about 10% to about 25%, or about 15% to about 25%.

The SAD carboxylic polyolefin elastomeric ionomers may have a complex viscosity, as measured by SAOS at 190° C. over an angular frequency of 0.1 rad/s to 100 rad/s, in the range of about 1000 Pa·s to about 100,000 Pa·s, encompassing any value and subset therebetween, such as about 1000 Pa·s to about 10,000 Pa·s, or about 10,000 Pa·s to about 25,000 Pa·s, or about 25,000 Pa·s to about 50,000 Pa·s, or about 50,000 Pa·s to about 75,000 Pa·s, or about 75,000 Pa·s to about 100,000 Pa·s.

The SAD carboxylic polyolefin elastomeric ionomers may have a zero shear viscosity, as measured by SAOS at 190° C., in the range of about 2.0E+04 Pa·s to about 4.0E+04 Pa·s, encompassing any value and subset therebetween, such as about 2.5E+04 Pa·s to about 3.5E+04 Pa·s, or about 2.5E+04 Pa·s to about 3.0E+04 Pa·s.

The SAD carboxylic polyolefin elastomeric ionomers may have a complex modulus (G*), as measured by SAOS at 190° C. over phase angle of 0° to 100°, in the range of about 10 MPa to about 100 MPa, encompassing any value and subset therebetween, such as about 10 MPa to about 25 MPa, or about 25 MPa to about 50 MPa, or about 50 MPa to about 75 MPa, or about 75 MPa to about 100 MPa.

The SAD carboxylic polyolefin elastomeric ionomers may have a propylene-ethylene polymer content in the range of about 80 wt % to about 98 wt %, encompassing any value and subset therebetween, such as about 80 wt % to about 85 wt %, or about 85 wt % to about 90 wt %, or about 90 wt % to about 95 wt %, or about 95 wt % to about 98 wt %. An example of a suitable propylene-ethylene polymer is EXXONMOBIL VISTAMAXX™ 6100 (Texas, USA) having an ethylene content of about 16 wt %, a density of about 0.86 grams per cubic centimeter (g/cm³), a melt flow rate (MFR) (230° C., 2.16 kilograms (kg)) of about 3 g/10 min, a heat of fusion of about 29 Joules per gram (J/g) and a melting point of about 56° C. to 62° C.

The SAD carboxylic polyolefin elastomeric ionomers may have a CBSA content in the range of about 0.1 wt % to about 10 wt %, encompassing any value and subset therebetween, such as about 0.1 wt % to about 1 wt %, or about 1 wt % to about 2.5 wt %, or about 2.5 wt % to about 5 wt %, or about 5 wt % to about 7.5 wt %, or about 7.5 wt % to about 10 wt %.

The SAD carboxylic polyolefin elastomeric ionomers may have a ZnO content in the range of about 0.1 wt % to about 10 wt %, encompassing any value and subset therebetween, such as about 0.1 wt % to about 1 wt %, or about 1 wt % to about 2.5 wt %, or about 2.5 wt % to about 5 wt %, or about 5 wt % to about 7.5 wt %, or about 7.5 wt % to about 10 wt %.

The SAD carboxylic polyolefin elastomeric ionomers may have a ZnSt content in the range of about 0.1 wt % to about 20 wt %, encompassing any value and subset therebetween, such as about 0.1 wt % to about 1 wt %, or about 1 wt % to about 5 wt %, or about 5 wt % to about 10 wt %, or about 10 wt % to about 15 wt %, or about 15 wt % to about 20 wt %.

In one or more aspects, the SAD carboxylic polyolefin elastomeric ionomers may have a ZnO content in the range of about 0.1 wt % to about 10 wt %, encompassing any value and subset therebetween, in combination with a ZnSt content in the range of about 0.1 wt % to about 20 wt %, encompassing any value and subset therebetween.

### Potassium Hydroxide Carboxylic Propylene Elastomeric Ionomers

In one or more aspects of the present disclosure, provided are carboxylic propylene elastomeric ionomers grafted with maleic acid and ionomerized via a reaction with potassium hydroxide (KOH). It is to be appreciated that while the following description is with reference to maleic acid, other acid hydrides, such as succinic hydride, and other metal hydroxides, such as those containing calcium and/or sodium, may be substituted, without departing from the scope of the present disclosure.

The KOH propylene elastomeric ionomers show a higher melt viscosity and modulus at low angular frequency range, which is an indication of higher melt strength, compared to control maleic acid elastomers. Indeed, the tensile stress and elongation, as measured at 190° C., of the KOH propylene elastomeric ionomers indicate improved melt strength due to the KOH ionomerization.

The KOH propylene elastomeric ionomers are mechanically melt mixed at a temperature in the range of about 100° C. to about 200° C. in the absence of a free-radical initiator in a BRABENDER™ mixer at 60 revolutions per minute (rpm) until torque was stabilized. The KOH propylene elastomeric ionomers thus produced showed exceptional elastic properties at high temperatures. Additionally, the KOH propylene elastomeric ionomers show good high temperature processability as measured by small amplitude oscillatory shear.

The KOH propylene elastomeric ionomers are prepared via a reaction with a maleic acid grafted propylene-based elastomer and KOH. Alternatively, a succinic acid may be used to graft the propylene-based elastomers described herein, without departing from the scope of the present disclosure.

The KOH propylene elastomeric ionomers may have a tensile strength at 190° C. of about 5 MPa to about 500 MPa, encompassing any value and subset therebetween, such as 5 MPa to about 100 MPa, or about 100 MPa to about 250 MPa, or about 250 MPa to about 500 MPa.

The KOH propylene elastomeric ionomers may have an ultimate elongation at 190° C. of about 150% to about 700%, encompassing any value and subset therebetween, such as about 150% to about 300%, or about 300% to about 450%, or about 450% to about 600%, or about 600% to about 700%.

The KOH propylene elastomeric ionomers may have a complex viscosity, as measured by SAOS at 190° C. over an angular frequency of 0.1 rad/s to 100 rad/s, in the range of about 500 Pa·s to about 1,000,000 Pa·s, encompassing any value and subset therebetween, such as about 500 Pa·s to about 200,000 Pa·s, or about 200,000 Pa·s to about 400,000 Pa·s, or about 400,000 Pa·s to about 600,000 Pa·s, or about 600,000 Pa·s to about 800,000 Pa·s, or about 800,000 Pa·s to about 1,000,000 Pa·s.

The KOH propylene elastomeric ionomers may have a complex viscosity, as measured by DMTA over a temperature in the range of −50° C. to 200° C., in the range of about 1.0E+04 Pa·s to about 1.0E+08 Pa·s, encompassing any value and subset therebetween, such as about 1.0E+04 Pa·s to about 1.0E+05 Pa·s, or about 1.0E+05 Pa·s to about 1.0E+06 Pa·s, or about 1.0E+06 Pa·s to about 1.0E+07 Pa·s, or about 1.0E+07 Pa·s to about 1.0E+08 Pa·s.

The KOH propylene elastomeric ionomers may have a storage modulus, as measured by SAOS at 190° C. over an angular frequency of 0.1 rad/s to 100 rad/s, in the range of about 10 MPa to about 100,000 MPa, encompassing any value and subset therebetween, such as about 10 MPa to about 1,000 MPa, or about 1,000 MPa to about 25,000 MPa, or about 25,000 MPa to about 50,000 MPa, or about 50,000 MPa to about 75,000 MPa, or about 75,000 MPa to about 100,000 MPa.

The KOH propylene elastomeric ionomers may have a storage modulus, as measured by DMTA over a temperature in the range of −50° C. to 200° C., 1.0E+04 MPa to about 1.0E+09 MPa, encompassing any value and subset therebetween, such as about 1.0E+04 MPa to about 1.0E+05 MPa, or about 1.0E+05 MPa to about 1.0E+06 MPa, or about 1.0E+06 MPa to about 1.0E+07 MPa, or about 1.0E+07 MPa to about 1.0E+08 MPa, or about 1.0E+08 MPa to about 1.0E+09 MPa.

The KOH propylene elastomeric ionomers may have a loss modulus, as measured by SAOS at 190° C. over an angular frequency of 0.1 rad/s to 100 rad/s, in the range of about 10 MPa to about 100,000 MPa, encompassing any value and subset therebetween, such as about 10 MPa to about 1,000 MPa, or about 1,000 MPa to about 25,000 MPa, or about 25,000 MPa to about 50,000 MPa, or about 50,000 MPa to about 75,000 MPa, or about 75,000 MPa to about 100,000 MPa.

The KOH propylene elastomeric ionomers may have a loss modulus, as measured by DMTA over a temperature in the range of −50° C. to 200° C., 1.0E+04 MPa to about 1.0E+08 MPa, encompassing any value and subset therebetween, such as about 1.0E+04 MPa to about 1.0E+05 MPa, or about 1.0E+05 MPa to about 1.0E+06 MPa, or about 1.0E+06 MPa to about 1.0E+07 MPa, or about 1.0E+07 MPa to about 1.0E+08 MPa.

As measured by DMTA, tan delta represents damping, the dissipation of energy in a material under cyclic load and is determined by the ratio of loss modulus to storage modulus. The KOH propylene elastomeric ionomers may have a tan delta, as measured by DMTA over a temperature in the range of −50° C. to 200° C., 0.15 to about 50, encompassing any value and subset therebetween, such as about 0.5 to about 10, or about 10 to about 25, or about 25 to about 50.

The KOH propylene elastomeric ionomers may have a melt temperature (Tₘ) in the range of about 110° C. to about 170° C., or from about 140° C. to about 168° C., or from about 160° C. to about 165° C., encompassing any value and subset therebetween. In one or more aspects, they may have a crystallization temperature (T_{c}) of at least about 60° C., or at least about 80° C., or at least about 70° C., or at least 75° C.

The KOH propylene elastomeric ionomers may be semi-crystalline polymers. Crystallinity (ΔH) may be determined by dividing the heat of fusion of a sample by the heat of fusion of a 100% crystalline polymer, which is assumed to be 290 joules/gram (J/g). These KOH propylene elastomeric ionomers may be characterized by a crystallinity of from about 5 J/g to about 20 J/g, encompassing any value and subset therebetween, or at least about 6 J/g, or at least J/g, or in the range of about 6 J/g to about 8 J/g.

The KOH propylene elastomeric ionomers may have a tensile strength of about 10 MPa to about 15 MPa, encompassing any value and subset therebetween, such as 10 MPa to about 12 MPa, or about 12 MPa to about 15 MPa.

The KOH propylene elastomeric ionomers may have an ultimate elongation of about 900% to about 1,200%, encompassing any value and subset therebetween, such as about 900% to about 1,000%, or about 1,000% to about 1,100%, or about 1,100% to about 1,200%.

The KOH propylene elastomeric ionomers may have a maleic acid grafted propylene-ethylene polymer content in the range of about 90 wt % to about 99.5 wt %, encompassing any value and subset therebetween, such as about 90 wt % to about 95 wt %, or about 95 wt % to about 99.5 wt %. An example of a suitable maleic acid grafted propylene-ethylene polymer is ACTI-TECH™ 16MA13 (California, USA) having a MFR (230° C., 2.16 kilograms (kg)) of about 10 g/10 min, and a grafting level of 0.5%. Another example of a suitable maleic acid grafted propylene-ethylene polymer is EXXONMOBILE VISTAMAXX™ V350 (Texas, USA) having a MFR (230° C., 2.16 kilograms (kg)) of about 50 g/10 min, and a grafting level of 1.0% or greater.

The KOH propylene elastomeric ionomers may have a KOH content in the range of about 0.5 wt % to about 10 wt %, encompassing any value and subset therebetween, such as about 0.5 wt % to about 1% wt %, or about 2.5 wt % to about 5 wt %, or about 5 wt % to about 7.5 wt %, or about 7.5 wt % to about 10 wt %. In some instances, the KOH content is 0.5 wt % or 1 wt %.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the incarnations of the present inventions. At the very least, and not as an attempt to limit the application of the doctrine of equivalents to the scope of the claim, each numerical parameter should at least be construed in light of the number of reported significant digits and by applying ordinary rounding techniques.

One or more illustrative incarnations incorporating one or more invention elements are presented herein. Not all features of a physical implementation are described or shown in this application for the sake of clarity. It is understood that in the development of a physical embodiment incorporating one or more elements of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

While compositions and methods are described herein in terms of “comprising” various components or steps, the compositions and methods can also “consist essentially of” or “consist of” the various components and steps.

### EMBODIMENTS

Embodiments of the present disclosure include:

Embodiment A: A functionalized polyolefin elastomeric ionomer composition comprising: a reaction product of: a polyolefin component; at least 0.1 parts by weight of a sulfonyl azide derivative component, the sulfonyl azide derivative component functionalizing the polyolefin component, wherein the sulfonyl azide derivative component comprises at least one of an organic anhydride compound or an organic acid compound, and wherein the sulfonyl azide derivative component is present in an amount of per 100 parts by weight of polyolefin component; and a metal-based neutralizing agent component containing an elemental metal or a metal compound comprising at least one of aluminum, calcium, magnesium, sodium, and zine, wherein a degree of neutralization of the one or both organic anhydride component or organic acid component of the sulfonyl azide derivative component is at least 20%.

Embodiment B: A method comprising melt mixing: a polyolefin component; at least 0.1 parts by weight of a sulfonyl azide derivative component, the sulfonyl azide derivative component functionalizing the polyolefin component, wherein the sulfonyl azide derivative component comprises at least one of an organic anhydride compound or an organic acid compound, and wherein the sulfonyl azide derivative component is present in an amount of per 100 parts by weight of polyolefin component, and a metal-based neutralizing agent component containing an elemental metal or a metal compound comprising at least one of aluminum, calcium, magnesium, sodium, and zinc, wherein a degree of neutralization of the one or both organic anhydride component or organic acid component of the sulfonyl azide derivative component is at least 20%.

Nonlimiting example Embodiments A and B may include one or more of the following Elements:

Element 1: wherein the polyolefin component is a propylene-ethylene copolymer.

Element 2: wherein the sulfonyl azide derivative component is selected from the group consisting of 4-carboxybenzenesulonazide (CBSA), 3-azidosulfonylbenzoic acid, 5-(azidosulfonyl) endo-cis-bicyclo[2.2.1]heptane-2,3-dicarboxylic anhydride, 3-(2,5-dioxotetrahydrofuran-3-yl)-2-methylpropane-1-sulfonyl azide, and any combination thereof.

Element 3: wherein the metal-based neutralizing agent compound is a carboxylated copolymer of a calcium, or a zinc carboxylate based on an acid compound selected from the group consisting of linear and branched monocarboxylic acids having at least 12 carbon atoms per molecule.

Element 4: wherein the metal-based neutralizing agent compound is a zinc carboxylate based on linear monocarboxylic fatty acids having at least 12 carbon atoms per molecule.

Element 5: wherein the metal-based neutralizing agent is a metal hydroxide or a metal oxide of at least one of aluminum, calcium, magnesium, sodium, and zinc.

Element 6: wherein the metal-based neutralizing agent is calcium stearate or zinc stearate.

Element 7: wherein the melt mixing is performed using a reactor or an extruder.

Element 8: wherein the melt mixing is performed at a temperature of about 100° C. to about 200° C.

By way of non-limiting example, exemplary combinations applicable to A include, but are not limited to, 1 and 2, 1 and 3, 1 and 4, 1 and 5, 1 and 6, 2 and 3, 2 and 4, 2 and 5, 2 and 6, 3 and 4, 3 and 5, 3 and 6, 4 and 5, 4 and 6, and any combination of 1, 2, 3, 4, 5, and 6, without limitation.

By way of non-limiting example, exemplary combinations applicable to B include, but are not limited to, 1 and 2, 1 and 3, 1 and 4, 1 and 5, 1 and 6, 1 and 7, 1 and 8, 2 and 3, 2 and 4, 2 and 5, 2 and 6, 2 and 7, 2 and 8, 3 and 4, 3 and 5, 3 and 6, 3 and 7, 3 and 8, 4 and 5, 4 and 6, 4 and 7, 4 and 8, 5 and 6, 5 and 7, 5 and 8, 6 and 7, 6 and 8, 7 and 8, and any combination of 1, 2, 3, 4, 5, 6, 7, and 8, without limitation.

Embodiment C. A carboxylic propylene elastomeric ionomer composition comprising: the reaction product of: a polyolefin component grafted with an acid hydride; and a hydroxide metal-based neutralizing agent component containing an elemental metal or a metal compound comprising at least one of potassium, sodium, or calcium.

Nonlimiting example Embodiment C may include one or more of the following Elements:

Element 9: wherein the acid hydride is maleic anhydride or succinic anhydride.

Element 10: wherein the hydroxide metal-based neutralizing agent is potassium hydroxide.

Element 11: wherein the polyolefin component is a propylene-ethylene copolymer.

By way of non-limiting example, exemplary combinations applicable to C include, but are not limited to, 9 and 10, 9 and 11, 10 and 11, and any combination of 9, 10, and 11, without limitation.

To facilitate a better understanding of the embodiments of the present invention, the following examples of preferred or representative embodiments are given. In no way should the following examples be read to limit, or to define, the scope of the invention.

### EXAMPLES

Example 1. In this example, two experimental ABA propylene elastomeric ionomers were prepared per the present disclosure and using EXXONMOBIL VISTAMAXX™ 6100 (without RCP) (VMX6100), CBSA (SIGMA ALDRICH, CAS #17202-49-2, Missouri, USA), ZnO, and ZnSt. The experimental ionomers are labeled IEx1 and 1Ex2 and were compositionally prepared according to Table 1.

TABLE 1

| | | |
|---|---|---|
| Ingredient | IEx1 | IEx2 |

| | | | | |
|---|---|---|---|---|
| VMX6100 | 98 | wt % | 96 | wt % |
| CBSA | 2 | wt % | 4 | wt % |
| ZnO | 2 | wt % | 3 | wt % |
| ZnSt | 8 | wt % | 15 | wt % |

The experimental samples were fluxed using a BRABENDER® mixer (Duisburg, Germany) and samples are mixed at 190° C. The VMX6100 was added to the mixing bowl and allowed to melt for 3 min or until torque stabilized. Then the CBSA powder was added and allowed to react with the polymer for 3 min after which the ZnO and ZnSt were added to convert the grafted carboxylic acid to ionic salts. Finally IRGANOX™ 1010 (BASF, Ludwigshafen, Germany) was added as stabilizer.

The properties of IEx1 and IEx2 were compared to VMX6100 as a control. The results are provided in Table 2.

TABLE 2

| Property | VMX6100 | | IEx1 | | IEx2 | |
|---|---|---|---|---|---|---|
| Shore A Hardness | 57 | | 52 | | 53 | |
| 100% Modulus | 1.4 | MPa | 1.2 | MPa | 1.3 | MPa |
| Tensile Strength | 10.7 | MPa | 11.7 | MPa | 10.5 | MPa |

| Ultimate Elongation | 908% | 817% | 739% |
|---|---|---|---|
| 25% Tension Set | Failed | 24 | 22.8 |
| 50% Tension Set | Failed | 48.8 | 46 |

As shown in Table 2, the experimental ABA elastomeric ionomers exhibit tensile properties and hardness values that are comparable to control VMX6100. However, when elastic properties are measured via tension set at 70° C. using an extension of 25% and 50%, the ionomers exhibit superior function.

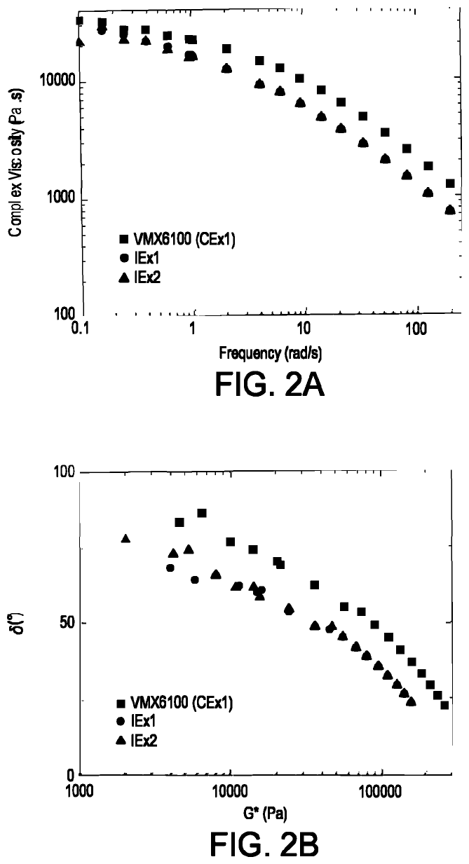

Each of experimental samples IEx1 and IEx2 and control sample VMX6100 were evaluated for rheological properties at 190° C. using SAOS. The results are shown in Table 3 below, and shown in FIG. 2A for complex viscosity and FIG. 2B for shear modulus (van Gurp-Palmen (VGP) plot).

TABLE 3

| | Cross Model Constants | | | Cross Over | |
|---|---|---|---|---|---|
| | ZSV | Time | | w_{c} | G_{c} |
| Sample | (Pa · s) | (sec) | n | (rad/s) | (Pa) |
| VMX6100 | 2.9E+04 | 2.5E−01 | 0.77 | 11.26 | 7.4E+04 |
| IEx1 | 3.1E+04 | 8.0E−01 | 0.70 | 9.11 | 3.9E+04 |
| IEx2 | 2.7E+04 | 5.9E−01 | 0.73 | 7.97 | 3.8E+04 |

Plateau Modulus

| | G_{NO} | d VGP @ | G_{NO} | RVGP |
|---|---|---|---|---|
| | Extrapol | G* = 105 Pa | Integ | Area |
| Sample | (Pa) | (°) | (Pa) | (°) |
| VMX6100 | 5.5E+05 | 47.4 | 4.4E+05 | 26.5 |
| IEx1 | 4.0E+05 | 38.4 | 3.0E+05 | 21.0 |
| IEx2 | 3.4E+05 | 35.1 | 3.0E+05 | 21.5 |

As provided in Table 3 and FIGS. 2A and 2B, the ABA elastomeric ionomers are comparable to the control sample and thus exhibit proper rheological properties.

The properties of IEx1 were compared to several additional controls, including 100% elongation (Methods 3 and 4). The controls included VMX6100, INFUSE™ 9507 (DOW CHEMICAL, Michigan, USA, an olefin block copolymer), INFUSE™ 9100 (DOW CHEMICAL, Michigan, USA, an olefin block copolymer), and KRATON™ G1657 (KRATON CORPORATION, Texas, USA, a styrene and ethylene/butylene copolymer). The results are shown in Table 4.

TABLE 4

| | | | INFUSE ™ | INFUSE ™ | KRATON ™ |
|---|---|---|---|---|---|
| Property | VMX6100 | IEx1 | 9507 | 9100 | G1657 |
| Shore A | 57 | 52 | 60 | 75 | 47 |
| Hardness | | | | | |
| 100% | 1.4 MPa | 1.2 MPa | 1.5 MPa | 2.5 MPa | 1.3 MPa |
| Modulus | | | | | |
| Tensile | 10.7 MPa | 11.7 MPa | 4.9 MPa | 10.0 MPa | 11.2 MPa |
| Strength | | | | | |
| Ultimate | 908% | 817% | 1300% | 1300% | 670% |
| Elongation | | | | | |
| 100% | 9.2% | 7.7% | 10.5% | 12.2% | 4.3% |
| Tension Set | | | | | |
| (Method 3) | | | | | |
| 100% | 28.2% | 12.8% | 34.2% | 26.3% | 10.5% |
| Tension Set | | | | | |
| (Method 4) | | | | | |
| Tackiness | Very | Not | Not | Not | Slightly |
| (Observed) | tacky | tacky | tacky | Tacky | tacky |

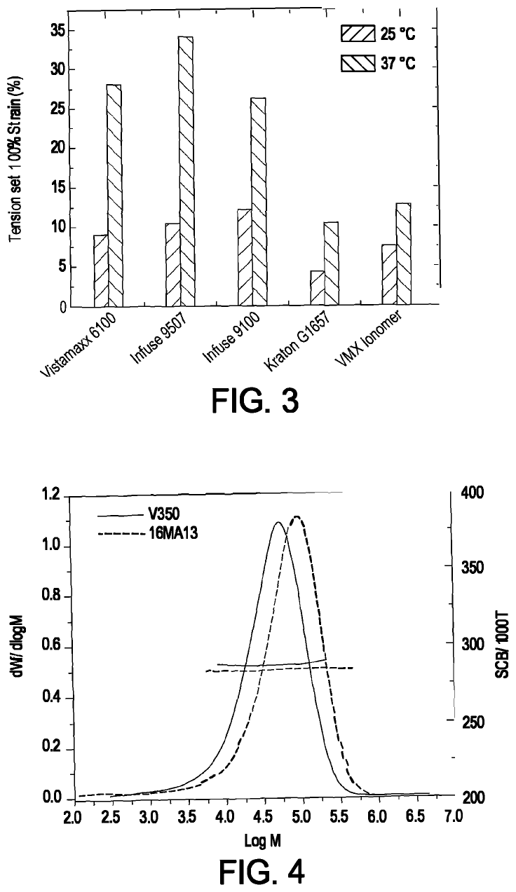

As shown in Table 4, the experimental ABA elastomeric ionomer shows excellent tensile properties in comparison to most of the control copolymers. Further, the experimental ionomer is able to attain excellent elastic properties at both room temperature and body temperature conditions, as graphically shown in FIG. 3, and shows no tackiness.

Example 2. In this example, six experimental KOH propylene elastomeric ionomers were prepared per the present disclosure and using either EXXONMOBIL VISTAMAXX™ V350 (V350) or ACTI-TECH™ 16MA13, as described above, and compared to three control samples of V350, V350 ionomerized with zinc acetate (ZnAc).

First, the maleic acid (MA) content of each of V350 and 16MA13 was evaluated using FTIR. The MA content was calculated according to the following equation:

Ratio=(Peak1710+Peak1780+Peak1850)/Film thic(mm)

To confirm the component of MA monomer residue to grafted MA content, a comparison was made between neat V350 and neat 16MA13 to annealed V350 and neat 16MA13. Annealing was performed in an oven overnight at 110° C. The results are shown in Table 5 below.

TABLE 5

| | Peak 1850 | Peak 1850 | Peak 1850 | SUM | MA Content |
|---|---|---|---|---|---|
| Sample | (cm⁻¹) | (cm⁻¹) | (cm⁻¹) | (Σ, cm⁻¹) | (%) |
| 16MA13 | 0.040 | 0.226 | 0.217 | 0.483 | 0.78% |
| 16MA14 | 0.063 | 0.347 | 0.03 | 0.44 | 0.71% |
| (annealed) | | | | | |
| V350 | 0.013 | 0.06 | 0.19 | 0.263 | 0.42% |
| V350 | 0.025 | 0.13 | 0.009 | 0.164 | 0.26% |
| (annealed) | | | | | |

As shown in Table 5, the MA content is greater in the 16MA13 sample.

Thereafter, molecular weight distribution was determined using Gel Permeation Chromatograph, as described above. The resultant differential molecular weight (dWf/dLogM) curve is provided in FIG. 4 and the results are listed in Table 6 below. C2% is the amount of ethylene.

TABLE 6

| | Mn | Mw | | Commoner | |
|---|---|---|---|---|---|
| Sample | (g/mol) | (g/mol) | Mw/Mn | (C2%) | g′_{avg} |
| V350 | 20100 | 86700 | 4.31 | 14.5% | 1.13 |
| 16MA13 | 22800 | 98900 | 4.33 | 13.3% | 1.05 |

As shown, the molecular weight of both V350 and 16MA13, as well as ethylene content, are comparable.

The six experimental samples and control samples were prepared as described herein in a BRABENDER™ mixer (60 rpm until torque was stabilized) and the temperature and concentrations below in Table 7.

TABLE 7

| | Process |
|---|---|
| Formulation (wt %) | condition (° C.) |
| V350 / 1% KOH | 110 |
| V350 / 1% KOH | 150 |
| V350 /1% KOH | 200 |
| V350 /0.5% KOH | 150 |
| 16MA13 /1% KOH | 150 |
| 16MA13 /0.5% KOH | 150 |
| V350 (Control) | 150 |
| 16MA13 (Control) | 150 |
| V350 / 1% ZnAc (Control) | 110 |

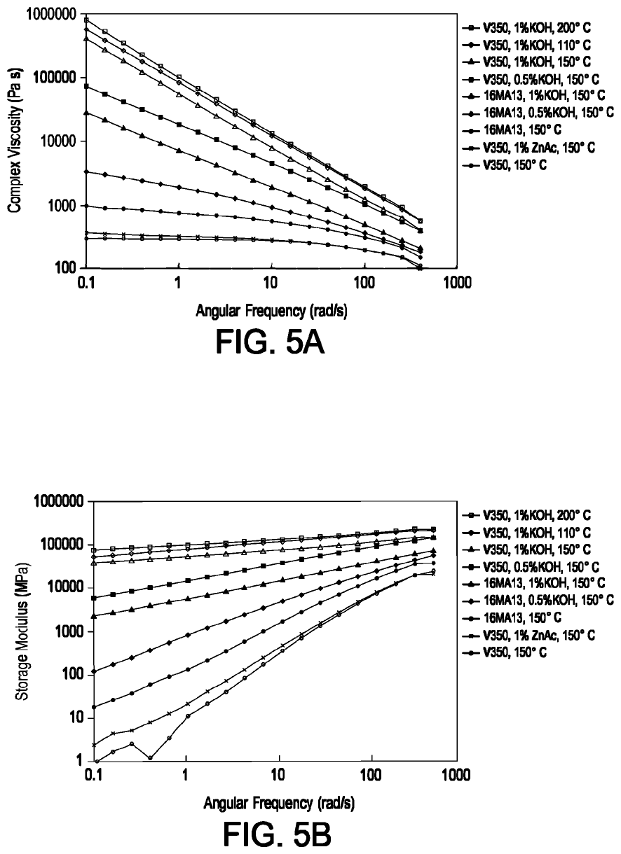

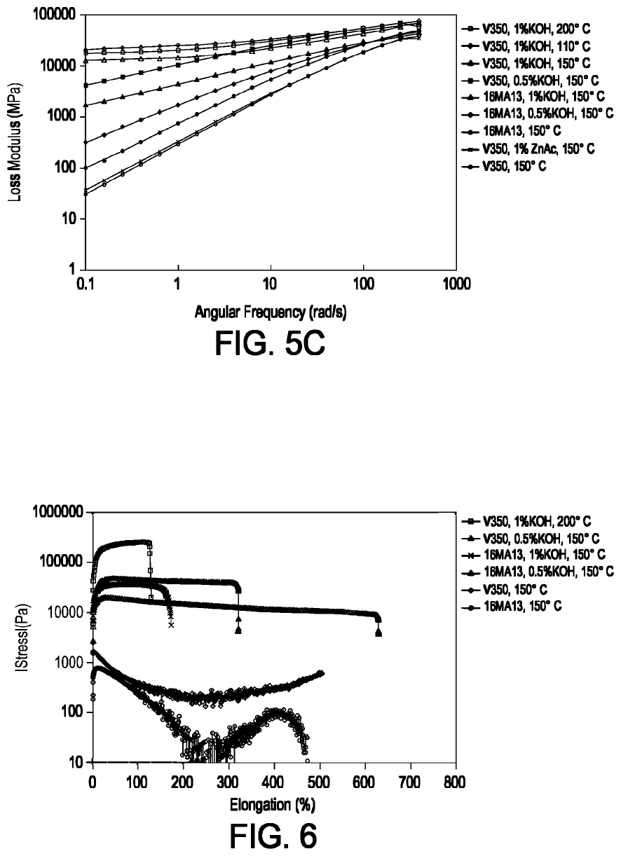

Each of experimental and control samples were evaluated for rheological properties at 190° C. using SAOS. The complex viscosity, storage modulus, and loss modulus results are shown in FIGS. 5A through 5C. As can be seen, the V350/1% ZnAc control shows no ionomerization effect, as its curves are nearly identical to V350 without the ZnAc added. However, the KOH samples all show ionomerization and give offset curves. Notably, the KOH ionomerization with V350 is stronger than with 16MA13. Accordingly, KOH is effective to ionomerize MA-grafted propylene elastomeric polymers and exhibit higher melt viscosity and modulus at low angular frequency range, an indication of higher melt strength.

The tensile strength (stress) and ultimate elongation of the samples (excluding the ZnAc control sample) were evaluated as described above at 190° C. The results are shown in FIG. 6. As shown, both V350 and 16MA13 sampled showed sagging with elongation, while this was not observed on KOH samples, indicating improved melt strength by ionomerization. Further, it is observed that the ionomerized products from V350 show higher tensile stress and lower elongation at break compared to those from 16MA13.

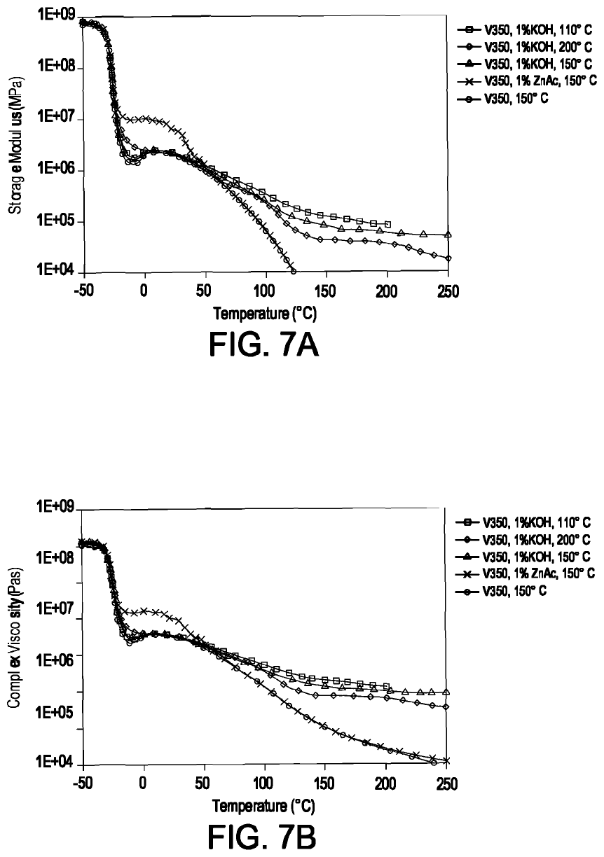

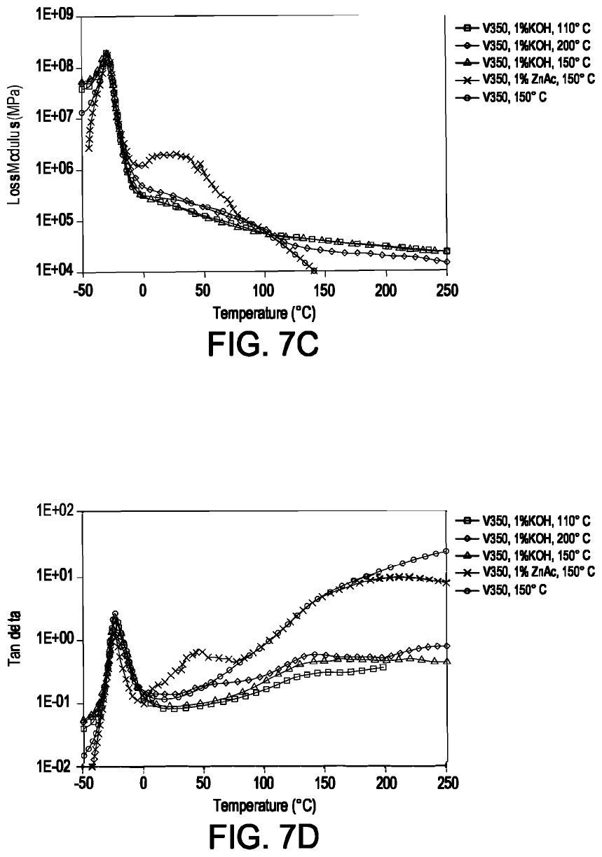

The V350 samples were tested using DMTA as described above and the results are provided in FIGS. 7A through 7D. As shown, the storage modulus and loss modulus of V350 with 1% KOH processed at various temperatures exhibits good retention at higher temperatures compared to V350 and V350 with 1% ZnAc, indicating improved thermal stability and the complex viscosity of V350 with 1% KOH at high temperatures, which would be an indication of improved melt strength. Additionally, the tan delta value of V350 with 1% KOH is lower than V350 and V350 with 1% ZnAc, indicating improved elasticity.

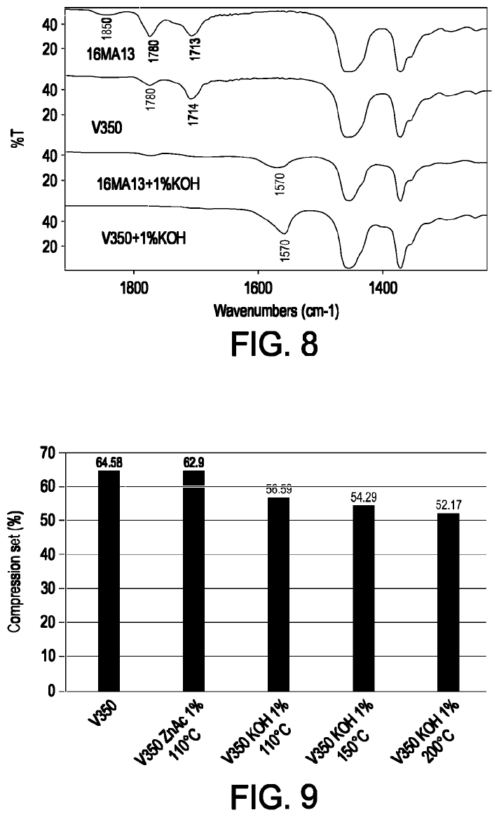

Referring now to FIG. 8, an FTIR plot is provided for the 1% KOH samples compared to control samples. The peak at 1780 cm⁻¹ represents the vibrational peak of C═O in MA, and 1710 cm⁻¹ is the symmetric C═O stretch of maleic acid. After neutralization, the signal shifts to 1570 cm⁻¹, the signal of asymmetric COO-stretch. As shown in FIG. 8, adding 1% KOH, the signals of 1710 cm⁻¹ and 1780 cm⁻¹ in V350 are no longer present, while such peaks in 16MA13 exhibit only a very weak signal, implying that MA group is fully or substantially fully neutralized.

The T_{c}, Tₘ, and ΔH of the 1% KOH (150° C.) samples compared to control samples. The results are shown in Table 8 below.

TABLE 8

| Formulation | Tc (° C.) | Tm (° C.) | ΔH (J/g) |
|---|---|---|---|
| V350 | 56.9 | 64.8, 145.6 | 9.0 |
| V350/1% KOH, 150° C. | 73.4 | 119.4 | 6.3 |
| V350/1% ZnAc, 150° C. | 69.7 | 115.7 | 7.7 |

With the KOH or ZnAc addition, the dual peak of Tₘ at 64.8 and 145.6° C. of control V350 changes to a single peak at around 115-120° C. The peak crystallization temperature increased compared to control V350, while the heat of crystallization does not change significantly, indicating the degree of crystallinity does not change substantially.

Compression set measurements were taken as described above (70° C., 22 hr, 25% reflection). The results are shown in FIG. 9. As shown, each of the 1% KOH experimental samples improved by roughly 15% compared to the control V350 sample, indicating higher elasticity of ionomerized product compared to V350. The results are in line with the result from DMTA.

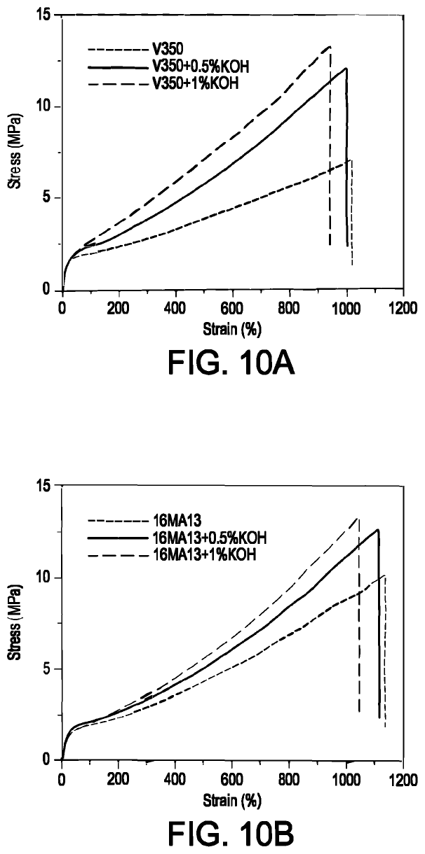

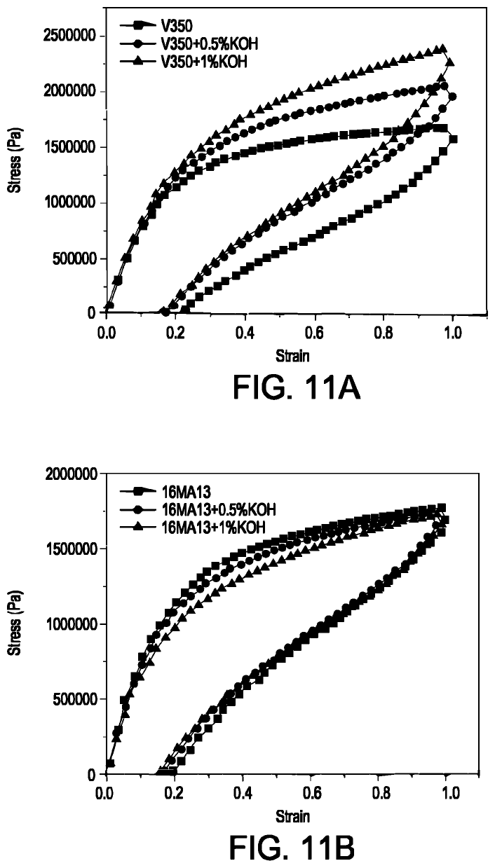

The tensile strength was measured at RT and tensile speed of 100 mm/min. Each of the KOH samples were processed at 150° C. The results are shown in FIGS. 10A and 10B. Elongation (elastic recovery) was measured at 1 mm/s and each of the KOH samples was processed at 150° C. The results are shown in FIGS. 11A and 11B. The tensile strength at break, broken elongation, tensile set, and hysteresis values are provided in Table 9 below.

TABLE 9

| | Tensile | | | |
|---|---|---|---|---|
| | Strength | Broken | | |
| | at Break | Elongation | Tensile | |
| Formulation | (MPa) | (%) | Set | Hysteresis |
| V350 | 7.0 | 1017 | 0.21 | 55.4% |
| V350/1% KOH, 150° C. | 12.0 | 1001 | 0.17 | 45.7% |
| V350/1% ZnAc, 150° C. | 13.2 | 942 | 0.17 | 47.9% |
| 16MA13 | 10.1 | 1136 | 0.20 | 46.8% |
| 16MA13/1% KOH, 150° C. | 12.5 | 1112 | 0.17 | 42.9% |
| 16MA13/1% ZnAc, 150° C. | 13.3 | 1044 | 0.16 | 40.4% |

As shown, all KOH samples exhibit broken elongation larger than 900%, indicating the good stretchability of ionomers. Further, the tensile strength increases in the KOH samples compared to the controls.

Therefore, the present invention is well adapted to attain the ends and advantages mentioned as well as those that are inherent therein. The particular examples and configurations disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative examples disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

What is claimed is:

1. A functionalized polyolefin elastomeric ionomer composition comprising:
a reaction product of:
a polyolefin component;
at least 0.1 parts by weight of a sulfonyl azide derivative component, the sulfonyl azide derivative component functionalizing the polyolefin component,
wherein the sulfonyl azide derivative component comprises at least one of an organic anhydride compound or an organic acid compound, and
wherein the sulfonyl azide derivative component is present in an amount of per 100 parts by weight of polyolefin component; and
a metal-based neutralizing agent component containing an elemental metal or a metal compound comprising at least one of aluminum, calcium, magnesium, sodium, and zine,
wherein a degree of neutralization of the one or both organic anhydride component or organic acid component of the sulfonyl azide derivative component is at least 20%.

2. The functionalized polyolefin elastomeric ionomer composition of claim 1, wherein the polyolefin component is a propylene-ethylene copolymer.

3. The functionalized polyolefin elastomeric ionomer composition of claim 1, wherein the sulfonyl azide derivative component is selected from the group consisting of 4-carboxybenzenesulonazide (CBSA), 3-azidosulfonylbenzoic acid, 5-(azidosulfonyl) endo-cis-bicyclo[2.2.1]heptane-2,3-dicarboxylic anhydride, 3-(2,5-dioxotetrahydrofuran-3-yl)-2-methylpropane-1-sulfonyl azide, and any combination thereof.

4. The functionalized polyolefin elastomeric ionomer composition of claim 1, wherein the metal-based neutralizing agent compound is a carboxylated copolymer of a calcium, or a zinc carboxylate based on an acid compound selected from the group consisting of linear and branched monocarboxylic acids having at least 12 carbon atoms per molecule.

5. The functionalized polyolefin elastomeric ionomer composition of claim 1, wherein the metal-based neutralizing agent compound is a zinc carboxylate based on linear monocarboxylic fatty acids having at least 12 carbon atoms per molecule.

6. The functionalized polyolefin elastomeric ionomer composition of claim 1, wherein the metal-based neutralizing agent is a metal hydroxide or a metal oxide of at least one of aluminum, calcium, magnesium, sodium, and zinc.

7. The functionalized polyolefin elastomeric ionomer composition of claim 1, wherein the metal-based neutralizing agent is calcium stearate or zinc stearate.

8. A method comprising:
melt mixing:
a polyolefin component;
at least 0.1 parts by weight of a sulfonyl azide derivative component, the sulfonyl azide derivative component functionalizing the polyolefin component,
wherein the sulfonyl azide derivative component comprises at least one of an organic anhydride compound or an organic acid compound, and
wherein the sulfonyl azide derivative component is present in an amount of per 100 parts by weight of polyolefin component; and
a metal-based neutralizing agent component containing an elemental metal or a metal compound comprising at least one of aluminum, calcium, magnesium, sodium, and zinc,
wherein a degree of neutralization of the one or both organic anhydride component or organic acid component of the sulfonyl azide derivative component is at least 20%.

9. The method of claim 8, wherein the melt mixing is performed using a reactor or an extruder.

10. The method of claim 8, wherein the melt mixing is performed at a temperature of about 100° C. to about 200° C.

11. The method of claim 8, wherein the polyolefin component is a propylene-ethylene copolymer.

12. The method of claim 8, wherein the sulfonyl azide derivative component is selected from the group consisting of 4-carboxybenzenesulonazide (CBSA), 3-azidosulfonylbenzoic acid, 5-(azidosulfonyl)endo-cis-bicyclo[2.2.1]heptane-2,3-dicarboxylic anhydride, 3-(2,5-dioxotetrahydrofuran-3-yl)-2-methylpropane-1-sulfonyl azide, and any combination thereof.

13. The method of claim 8, wherein the metal-based neutralizing agent compound is a carboxylated copolymer of a calcium, or a zinc carboxylate based on an acid compound selected from the group consisting of linear and branched monocarboxylic acids having at least 12 carbon atoms per molecule.

14. The method of claim 8, wherein the metal-based neutralizing agent compound is a zinc carboxylate based on linear monocarboxylic fatty acids having at least 12 carbon atoms per molecule.

15. The method of claim 8, wherein the metal-based neutralizing agent is a metal hydroxide or a metal oxide of at least one of aluminum, calcium, magnesium, sodium, and zinc.

16. The method of claim 8, wherein the metal-based neutralizing agent is calcium stearate or zinc stearate.

17. A carboxylic propylene elastomeric ionomer composition comprising:
the reaction product of:
a polyolefin component grafted with an acid hydride; and
a hydroxide metal-based neutralizing agent component containing an elemental metal or a metal compound comprising at least one of potassium, sodium, or calcium.

18. The carboxylic propylene elastomeric ionomer composition of claim 17, wherein the acid hydride is maleic anhydride or succinic anhydride.

19. The carboxylic propylene elastomeric ionomer composition of claim 17, wherein the hydroxide metal-based neutralizing agent is potassium hydroxide.

20. The carboxylic propylene elastomeric ionomer composition of claim 17, wherein the polyolefin component is a propylene-ethylene copolymer.
